(19) United States
(12) Patent Application Publication
(10) Pub. No.: US 2012/0109804 A1
(43) Pub. Date: May 3, 2012

(54) Social Network that enables lending and borrowing between components of the network using auction and reverse auction methods

(76) Inventors: Sandeep Subhash Gandhi, San Ramon, CA (US); Ashim Banerjee, Boulder, CO (US)

(21) Appl. No.: 13/068,869

(22) Filed: Oct. 29, 2010

(51) Int. Cl. G06Q 30/08

(52) U.S. Cl. 705/35

(57) ABSTRACT

A software application means comprising a social network for lending and borrowing funds and including a controller that provides a platform for contracting and funds transfer and whereby users bid in an auction platform either to lend or borrow. A means for creating and facilitating a chit fund whereby a group of users submit funds into a large fund after which bidding commences for a lesser amount than the final total value of the sum of user fund submissions and the lowest bidder receives the value of his bid, or in the alternative a prize with a set value that is analogous to the final total value of the user funds.

### CROSS REFERENCE TO RELATED APPLICATIONS

This nonprovisional application is a conversion of provisional application No. U.S. 61/408,095 titled “Social Network that enables lending and borrowing between components of the network using auction and reverse auction methods”.

### STATEMENT REGARDING FEDERALLY SPONSORED RESEARCH OR DEVELOPMENT

Not Applicable.

### BACKGROUND OF THE INVENTION

1. Field of the Invention

The present invention relates to internet based social networks. More specifically, the present invention relates to formal and informal money lending and borrowing systems.

2. Description of Related Art

There presently exist numerous means for sending and receiving money as well as applying for loans using the internet. One example found on the internet is www.Paypal.com which permits users to send and receive funds through common financial pathways for example where funds travel from one bank account to another in a given transaction. Online loan applications permit applicants to request a loan from a traditional financial institution or other lender. Finally, internet auction sites such as www.ebay.com permit private users to post items for sale, and other users to bid on said for sale items in an auction style offer.

There also exist numerous means for social networking on the internet, most famously the websites www.Facebook.com and www.Myspace.com. Social networking on these sites comprises user created content in a profile that is shared and interacted with among “friends” who are those people that a user has permitted to access their profile. A typical user may have 100-400 friends in their social network with whom they interact to varying degrees.

There does not exist, however, the present invention comprising a business method comprising an online social network where users become members for the purpose of borrowing and lending money. Users can post requests for funds or they can post funds available to be loaned. Fund requesters and fund providers separately invite bids for terms to contract for respective borrowing or lending money. Additionally, users can form a chit fund amongst themselves whereby after submitting funds to the chit fund, chit fund members bid ever decreasing amounts against each other beginning at the ultimate value of the chit fund.

### SUMMARY OF THE INVENTION

The general purpose of the foregoing application is to describe a business method whereby members join an social network for the purpose of borrowing or lending money within their network of “friends” who are those persons including business entities that a user permits to access their profile. Said social network is an application accessible by users on a website, mobile phone application, SMS, and/or any other communication means where users create an account and login for use and otherwise interact with a controller to enable borrowing or lending activity. A request funds mode, a provide funds mode, and a chit funds mode are three distinct operating modes for requesting funds, providing funds, and/or participating in a ‘chit fund’ as described below. In use, these modes are accessible to both individuals and sponsored entities that may include business entities and that create invitations to bid and bid in the same process as an individual. Therefore, for the purpose of this application, a ‘user’ refers to an individual and/or a sponsored entity.

A request funds mode permits a user to post a need for funds on their account. Said posting may be visible to a user's friends as well as sponsored entities or non-friends whom the user may invite to bid. Said posting creates the terms at which said user wishes to borrow funds including but not limited to: amount; payment schedule; and interest rate. Said posting terms may have unstated or negotiable values whereby said posting invitation may include an invitation to propose term values.

A provide funds mode permits a user to post a supply of available funds on their account. Said posting may be visible to a user's friends as well as sponsored entities or non-friends whom the user may invite to bid. Said posting creates the terms at which said user wishes to lend funds including but not limited to: amount; payment schedule; and interest rate. Said posting terms may have unstated or negotiable values whereby said posting invitation may include an invitation to propose term values.

A chit funds mode permits a user to participate in a chit fund. A chit fund comprises a group of users that come together to create a pool of funds from equal amount fund submissions. After the fund submission period ends, the ultimate value of the chit fund is distributed to a user either by lottery means, or alternatively via an auction means. Said chit fund auction means allows users bid to accept less than the ultimate value of the entire chit fund and whereby the user willing to accept the lowest amount is the winner of said auction means whereby the value of said user's bid is distributed to said winning bidder from said ultimate value, and whereby the remainder of the chit fund is either returned to the group as part of a new auction cycle or for other uses by those chit fund contributors. In the alternative, the subject of a chit fund auction may comprise a physical item or product (herein “prize”) that is distributed to a winning bidder in the auction process. A chit fund may be created by a single and/or a plurality of payments from each chit fund contributor. Friends may be invited to join a chit fund, and any user or group of users may originate a chit fund via invitations to join as a chit fund contributor.

All three of the above modes may include a bid acceptance process as described below and which may include a website controlled enabled contracting environment. Said environment comprises controller-generated means for binding parties to each other after bid acceptance, and agreed means for transferring funds between parties or in the alternative means for transferring a chit fund prize to an auction winner. Said transferring means comprises fund source and destination accounts that include but is not limited to Credit/Debit cards, Bank Accounts, Loyalty Points, Wallet Accounts, and Payroll accounts.

The characteristics and utilities of the present invention described in this summary and the detailed description below are not all inclusive. Many additional features and advantages will be apparent to one of ordinary skill in the art given the following drawings, specifications and claims. There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, by explaining at least one embodiment of the invention in detail, it is to be understood that the invention is not limited in its application to the details of construction and to the arrangements of the components set forth in the description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is therefore a purpose of the present invention to employ a user's network of friends to enable money borrowing or lending between user and said network of friends.

It is therefore a purpose of the present invention to comprise a marketplace for creating competitive bids for borrowing or lending money via auction means.

It is therefore a purpose of the present invention to create and sustain a user group chit fund comprising a means for submitting regular fund amounts to a publicly available fund from which another may borrow a portion of the chit funds.

### (BRIEF) DESCRIPTION OF THE DRAWINGS

The present invention may be better understood, and its numerous features and advantages made apparent to those skilled in the art by referencing the accompanying drawings. For ease of understanding and simplicity, common numbering of elements within the illustrations is employed to identify an element in the different drawings.

FIG. 1 is: a flowchart diagram indicating the process of a funds requester accepting a bid from a funds provider for funds.

FIG. 2 is: a flowchart diagram showing the process for bidding on available funds by a funds bidder that are submitted to a funds provider who has invited bids for their funds.

FIG. 3 is: a flowchart diagram showing processes for becoming part of a chit fund.

FIG. 3A is: a flowchart diagram showing the auction process after all chit fund submissions are received to comprise the ultimate chit fund amount.

### DETAILED DESCRIPTION

In use, a user enrolls into the social network by creating an account with the application controller. Said user can invite other users to become part of his social network that may or may not already have an account with said controller. After enrollment, a user may enter one of three modes: request funds mode; provide funds mode; or chit fund mode. In use, a user who wants to borrow funds has two options: said user may search his friends for those friends with a posting indicating that they have funds to lend; or said user may create his own posting in request funds mode and invite friends to competitively bid to make a loan to said user. A user who wants to lend funds has two options: said user may search his friends for those friends with a posting indicating that want to borrow funds; or said user may create his own posting in provide funds mode and invite friends to competitively bid for the funds he wishes to make available to loan. It is understood that while postings in either the request funds or provide funds modes may be for similar or same fund amounts, other terms such as repayment schedule and interest rate may vary. It is also understood that there are other modes from which to interact with the social network webpage incorporated into the present invention, including but not limited to: a search mode whereby a user can search for postings on fund requests, available funds for lending, and/or chit funds; and a mode by which others can be added to a user's list of friends comprising said user's network of friends, and through which a user can distribute invitations.

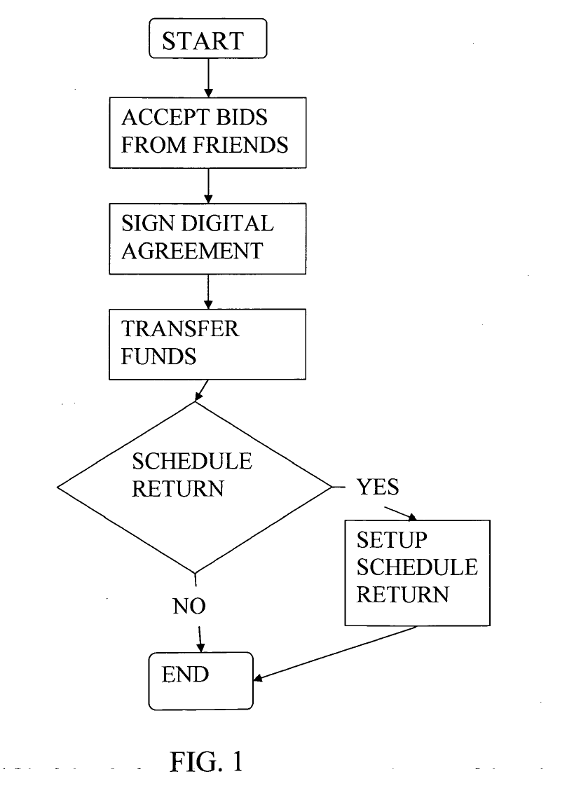

In request funds mode, a user creates a posting stating a need for a given amount of funds. Said posting may include terms at which a user is willing to borrow said given amount of funds. After creating the posting, friends and certain other users with permission are invited to bid on the posting. A winner may be chosen under a subjective decision as to the best offer by the user, or a winner may win automatically by having for example, the lowest interest rate or the longest repayment term. Upon final bid selection, a digital agreement created by the application controller with terms populated by the terms of the final bid is signed by both parties and funds are transferred to said user. A fund return schedule may be created as a separate agreement. See FIG. 1.

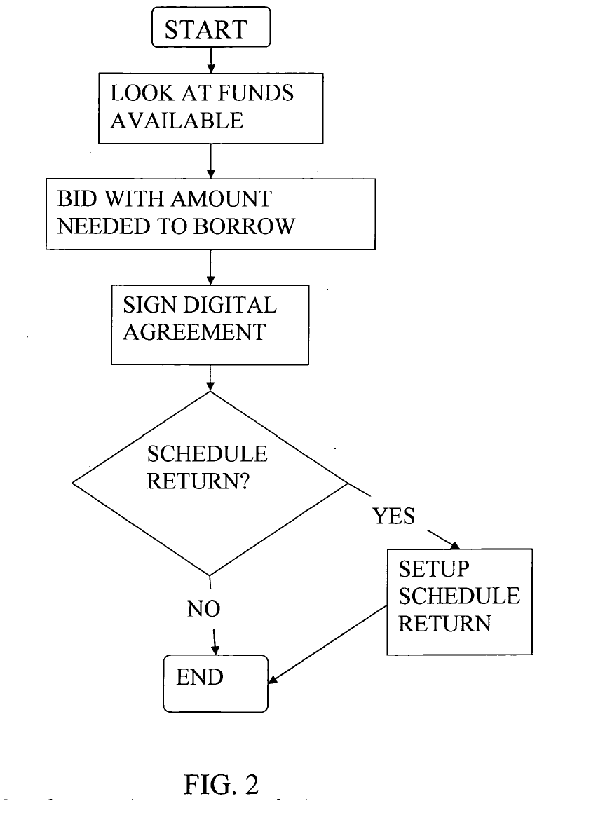

In provide funds mode, a user creates a posting indicating funds to lend. Said posting may include terms at which a user is willing to lend said given amount of funds. After creating the posting, friends and certain other users with permission are invited to bid on the posting. A winner may be chosen under a subjective decision as to the best offer by the user, or a winner may win automatically by having for example, the highest interest rate or the shortest repayment term. Upon final bid selection, a digital agreement created by the application controller with terms populated by the terms of the final bid is signed by both parties and funds are transferred to the winning bidder. A fund return schedule may be created as a separate agreement. See FIG. 2.

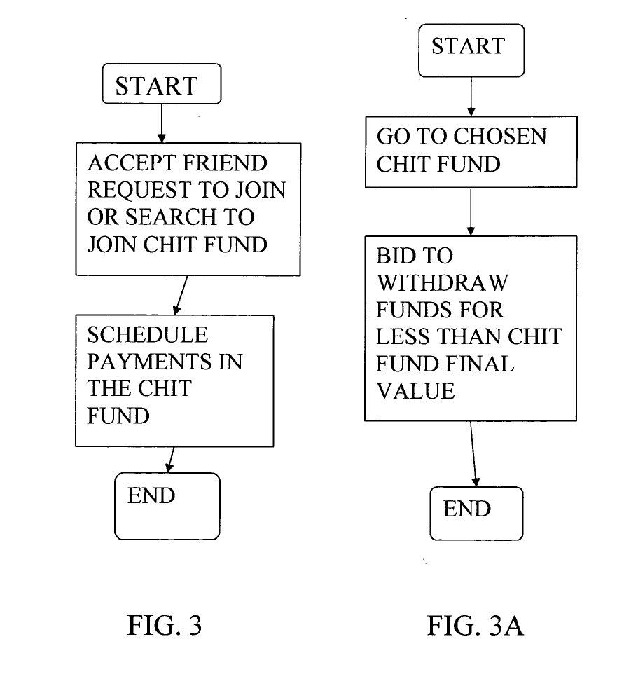

In chit funds mode, a user either joins an existing chit fund via an invitation from a friend or said user initiates a new chit fund one his own or as a group of chit fund initiators. Chit fund creation comprises creating a set of rules for the chit fund including but not limited to fund submission amount per user, number of submissions allowed per user, the ultimate value of the chit fund, whether the winner receives funds or a prize, and what to do with any remainder in the chit fund after the winning bid value is removed. In use, a user either accepts an invitation to join a chit fund or searches for and requests to be part of a chit fund. Said user then contributes to the chit fund as permitted by said rules. When the chit fund has reached the ultimate value under said rules, users begin bidding on amount less than the ultimate value of the chit fund. The lowest bidder wins and is transferred the value of his bid. The remainder of the chit fund is distributed per said chit fund rules. See FIGS. 3 and 3A.

The previous is a detailed description of illustrative embodiments of the present invention. As these embodiments of the present invention are described with references to the aforementioned drawings, various modifications or adaptations of the methods and or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings are not to be considered in a limiting sense, as it is understood that the present invention is in no way limited to the embodiments illustrated.

What is claimed is:

1. A business method comprising:

1) An software application means accessible by users on a website, mobile phone application, SMS, and/or any other communication means where users create an account and login for use and otherwise interact with a controller to enable borrowing or lending activity through a social networking means via a request funds mode, a provide funds mode, and a chit fund mode as three distinct operating modes for requesting funds, providing funds, and/or participating in a chit fund; in use, said social networking means comprises a request funds mode, provide funds mode and chit fund mode that are accessible to said account holders including both individuals and sponsored entities that may include business entities and that create invitations to bid and bid in the same process as an individual but that may or may not be in a user's account as an accepted member of said user's friend network comprising a user's “friend(s)”, and whereby all said account holders comprise a social network.

2) The request funds mode according to claim 1 whereby:
a user creates a posting stating a need for a given amount of funds and said posting may include terms at which a user is willing to borrow said given amount of funds;
after creating the posting, friends and certain other users with permission are invited to bid on the posting and a winner may be chosen under a subjective decision as to the best offer by the user, or a winner may win automatically by having, for example, the lowest interest rate or the longest repayment term;
upon final bid selection, a digital agreement created by the application controller with terms populated by the terms of the final bid is signed by both parties and funds are transferred to said user; and
a fund return schedule may be created as a separate agreement.

3) The provide funds mode according to claim 1 whereby:
a user creates a posting indicating funds to lend, said posting including terms at which a user is willing to lend said given amount of funds;
after creating the posting, friends and certain other users with permission are invited to bid on the posting;
a winner may be chosen under a subjective decision as to the best offer by the user, or a winner may win automatically by having for example, the highest interest rate or the shortest repayment term;
upon final bid selection, a digital agreement created by the application controller with terms populated by the terms of the final bid is signed by both parties and funds are transferred to the winning bidder; and
a fund return schedule may be created as a separate agreement.

4) The chit funds mode according to claim 1 whereby:
a user either joins an existing chit fund via an invitation from a friend or said user initiates a new chit fund one his own or as a group of chit fund initiators;
chit fund creation comprises creating a set of rules for the chit fund including but not limited to fund submission amount per user, number of submissions allowed per user, the ultimate value of the chit fund, whether the winner receives funds or a prize, and what to do with any remainder in the chit fund after the winning bid value is removed;
in use, a user either accepts an invitation to join a chit fund or searches for and requests to be part of a chit fund and said user then contributes to the chit fund as permitted by said rules;
when the chit fund has reached the ultimate value under said rules, users begin bidding on amount less than the ultimate value of the chit fund;
the lowest bidder wins and is transferred the value of his bid; and
the remainder of the chit fund is distributed per said chit fund rules.

5) The social networking means according to claim 1 comprising a means for:
soliciting membership in a user's friend network according to claim 1;
accepting a membership invitation in a user's friend network of claim 1 according to claim 1;
searching account holders in the social network of claim 1 according to claim 1;
creating and submitting bids according to claim 1;
creating and submitting bid invitations according to claim 1;
accept bids according to claim 1; and
contracting with a bidder or a user whose bid is accepted according to claim 1.
